(19) United States
(12) Patent Application Publication
(10) Pub. No.: US 2025/0085151 A1
(43) Pub. Date: Mar. 13, 2025

(54) CALIBRATION METHOD FOR A LIQUID SYSTEM

(71) Applicant: ibidi GmbH, Gräfelfing (DE)

(72) Inventor: Roman ZANTL, Baldham (DE)

(21) Appl. No.: 18/824,010

(22) Filed: Sep. 4, 2024

(30) Foreign Application Priority Data
Sep. 7, 2023 (EP) 23196001.4

(51) Int. Cl. G01F 23/263; G01F 1/00; G01F 23/18; G01F 23/292

(52) U.S. Cl. CPC G01F 23/266; G01F 1/007; G01F 23/18; G01F 23/265; G01F 23/2921

(57) ABSTRACT

A calibration method for a liquid system includes determining a filling level of liquid in a reservoir. The method further includes measuring, with a capacitance sensor, a first electrical capacitance at the reservoir for the filling level of the liquid. The method further includes setting a different filling level in the reservoir. The method further includes measuring, with the capacitance sensor, a second electrical capacitance at the reservoir for the different filling level. The method further includes determining a relationship between the filling level and the different filling level in the reservoir and the measured first electrical capacitance and the second electrical capacitance.

### RELATED APPLICATIONS

This application claims the benefit under 35 U.S.C. § 119 (a) of European Patent Application No. 23196001.4, filed Sep. 7, 2023, the entire content of which is hereby incorporated by reference.

### TECHNICAL FIELD

The present disclosure relates to a calibration method for a liquid system and to the associated liquid system.

### BACKGROUND

A liquid system (system filled with liquid), in particular a microfluid system, typically consists of two reservoirs that are fluidically connected to one another and to a flow chamber via a channel, where the liquid is driven from one reservoir to the other reservoir by the pressure difference between the two reservoirs. The pressure difference can be created by two independently controllable pressures in the reservoirs. The liquid is pumped through the flow chamber and can be used there, for example, as a nutrient solution for cell cultivation, but also for other applications.

Existing liquid systems are typically confined to adjusting the pressure difference between the two reservoirs so that a desired flow results therefrom. Certain variable flows (flow rates) are set by applying slowly changing pressures. Such a structure is used, for example, to simulate high blood pressure in order to investigate vascular constrictions and arteriosclerosis. In order to be able to provide the most realistic conditions possible for the simulations mentioned (and applications beyond that), it is important that the flow of the liquid is known precisely. In particular, it must also be possible to quickly detect a temporal variation in the flow.

### SUMMARY

Embodiments of the present disclosure provide a way of precisely determining the flow and its temporal progression in a fluid system. A calibration method and a liquid system are provided for this purpose. Further embodiments are described herein.

### BRIEF DESCRIPTION OF FIGURES

Further features and advantages shall be explained below using the exemplary figures, where:

FIG. 1 shows a first exemplary liquid system for carrying out the calibration method described;

FIG. 2 shows a second exemplary liquid system for carrying out the calibration method described;

FIG. 3A shows a schematic illustration of a capacitance barrier at a reservoir;

FIG. 3B shows a schematic illustration of an alternative capacitance barrier at a reservoir;

FIG. 3C shows a schematic illustration of an alternative capacitance barrier at a reservoir;

FIG. 3D shows an exemplary measurement of the capacitance as a function of the filling level with such a capacitance barrier;

FIG. 4A shows a schematic illustration of a first operation of a calibration method according to the invention;

FIG. 4B shows a schematic illustration of a second operation of a calibration method according to the invention;

FIG. 4C shows an exemplary diagram for determining a relationship between the measured capacitance and the filling level;

FIG. 5A shows a liquid system according to the invention according to a first embodiment, and

FIG. 5B shows a liquid system according to the invention according to a second embodiment.

Hereinafter and in the figures, the same reference characters shall be used for the same or corresponding elements in the various embodiments, unless otherwise specified.

### DETAILED DESCRIPTION

According to some embodiments, a calibration method for a liquid system, in particular for a microfluid system, is provided. The liquid system comprises a reservoir filled with a liquid and a capacitance sensor which is configured to measure an electrical capacitance at the reservoir. The method comprises the following steps of:
A) determining a filling level of the liquid in the reservoir;
B) measuring, with the capacitance sensor, the electrical capacitance at the reservoir for the filling level of the liquid determined in step A);
C) setting a different filling level in the reservoir,
D) repeating steps A) and B), and
E) determining a relationship between the filling levels in the reservoir and the electrical capacitances measured.

In step A), the filling level in the reservoir is therefore determined in an absolute manner. Step B) corresponds to a relative or indirect determination of a filling level by way of the capacitance measurement.

This calibration method therefore combines a relative measurement or determination of the filling level by measuring an electrical capacitance with an absolute determination of the filling level. The aim of this method is to determine a relationship or a functional connection between the electrical capacitance and the actual (absolute) filling level in the reservoir. To do this, the associated capacitance is determined for two different filling levels. From these relationships, the relationship sought between the filling levels and the electrical capacitance can be determined. In particular, the capacitance can be determined as a function of the filling level. This step of determining said relationship can comprise, for example, interpolation or extrapolation. The flow can then be derived from the relationship found and be determined with high precision.

A reservoir is understood to be a container that is configured to store liquid and to possibly receive it and dispense it again via an opening provided. The reservoir can be, for example, cylindrical, where the opening is disposed in the base surface or in the outer surface through which the liquid is pumped into the reservoir or drained from the reservoir.

The capacitance sensor can determine the electrical capacitance of part or the entire reservoir. This depends on the specific geometry of the reservoir and the capacitance sensor and/or their relative arrangement. The crucial factor there is that the capacitance measured behaves as a function of the filling level in the reservoir so that a changed filling level is also reflected in a changed capacitance. The capacitance of the liquid can depend on properties such as temperature, salt concentration or oxygen content. For this reason, a calibration from a capacitance measurement alone (step B)) has a certain inaccuracy. The second measurement according to step A) allows for an increase in the precision of the calibration.

The capacitance sensor can comprise, for example, two circuit boards that form a plate capacitor, where the reservoir or at least part of the reservoir is arranged between the circuit boards. When the reservoir is filled with a liquid, the capacitance measured changes with the filling level for the reason that the electrical permeability (or dielectric constant) of the liquid is higher than that of a gas disposed above the liquid, such as air. In a reservoir with a uniform cross-sectional area, the capacitance behaves almost linearly as a function of the filling level.

The method is not restricted to repeating steps A) and B) once. The method can instead also be extended by repeating steps A), B) and C) more than once in step D). This results in more value pairs of the filling level and the capacitance being determined or measured, which allows for more precise determination of the relationship between the filling levels in the first reservoir and the capacitances measured. In addition, the calibration can extend over a larger range of values.

The sequence of the steps of the method, in particular steps A) and B), is not fixed. In a further development, however, the steps of the method can be carried out in the sequence given.

The choice of the liquid itself depends on the specific field of application of the method and the liquid system and includes, for example, (distilled) water, nutrient solution for cell cultures, or blood.

The liquid system can furthermore comprise a second reservoir that is filled with a liquid. This is in particular the same liquid as in the first reservoir. The reservoir and the further reservoir can be connected in a liquid-tight manner via a channel, so that the reservoir and the further reservoir are reservoirs that communicated with regard to the liquid. Furthermore, each of the two reservoirs can be closed off from its surroundings and filled with a liquid and a gas, where the gas is arranged above the liquid in the respective reservoir and the two phases are separated from one another. For this liquid system, step A) of the method can comprise:
determining a pressure difference between the gas in the reservoir and the gas in the further reservoir, and
determining the filling level in the reservoir from the differential pressure.

Here and hereafter, if the liquid system comprises two reservoirs, the reservoir can be referred to as the first reservoir and the further reservoir as the second reservoir. In particular, the two reservoirs can have identical geometric dimensions and/or be arranged at the same height with respect to a common base area. The explanations given hereafter relate in part to these assumptions.

By arranging the channel that connects the two reservoirs such that the reservoirs are reservoirs that communicated with regard to the liquid, the liquid can flow back and forth through the channel between the two reservoirs. The channel enables liquid exchange between the two reservoirs.

Determining the filling level in the first and the second reservoir respectively gives rise to an absolute value for the filling level. This value arises from a measurement of the pressure difference, where the pressure difference arises from a corresponding difference in the filling level. Determining the filling level from a pressure measured is very precise and allows for a precise relationship between the capacitance and the filling level to be derived.

To determine the differential pressure, for example, a differential pressure sensor can be used that is connected to the gas phase of both reservoirs and therefore determines the pressure in the respective reservoir and the difference therefrom. Alternatively, the gas pressure can be determined separately in each reservoir, for example, using a suitable pressure sensor, and the difference can be calculated therefrom.

The filling level can be determined, for example, as follows. The starting point is a state in which filling level h is the same in both reservoirs. This filling level is set as the reference or zero point, for example, h=0 or referred to as h₀, and the associated capacitance is measured. A state in which the filling level in both reservoirs is different is then under consideration.

Pressure difference ΔP arises from the difference between gas pressure P₁ in the first reservoir and gas pressure P₂ in the second reservoir, i.e. ΔP=P₁−P₂, in particular ΔP=|P₁−P₂|. According to hydrostatic laws, the difference Δh in the filling level of the first reservoir and the second reservoir is then calculated according to Δh=ΔP/(ρg), where ρ is the density of the liquid and g is the acceleration due to gravity. If the two reservoirs have the same geometric dimensions, especially the same cross-section, the filling level in one of the reservoirs increases and in the other of the two reservoirs the filling level decreases to the same degree. Therefore, the height difference Δh determined is exactly twice the filling level h sought: h=Δh/2. Now capacitance C is measured for this filling level h (step B)) and a pair of values is obtained therefrom.

A changed filling level can be set for calibration, starting out from an equilibrium state in which the differential pressure is zero. This can be done, for example, in that the channel is closed, thereby changing the filling level in the reservoirs independently of each other and closing the reservoirs off from their surroundings again. The channel is opened again thereafter so that the two reservoirs communicate with each other. If this opening of the channel is carried out quickly, it can happen that the filling level in the two reservoirs begins to oscillate. The oscillation is damped and the frequency and type of oscillation (underdamped or overdamped) typically depend on system parameters such as the diameter of the channel.

The method can furthermore comprise measuring the pressure difference after a waiting period after setting the filling level, in particular when the liquid system has reached an equilibrium state in which the differential pressure is substantially constant over time. This improves the reliability of the determination of the filling level because the risk of pairs of values being recorded during an oscillation is reduced, which could distort the values.

In addition, the pressure difference can be measured at several points in time after the waiting period and averaged over the several points in time.

The averaging can be, for example, a geometric, arithmetic, or harmonic average. Overall, averaging the measured values from several points in time improves the accuracy of the measurement and hence the accuracy of the calibration. As mentioned, the averaging takes place when the liquid system has substantially or almost reached the equilibrium state. This is to mean that the amplitude of the oscillations in the filling level drops below a predetermined value (the amplitude of the oscillations decreases exponentially over time and therefore approaches the equilibrium state asymptotically. In reality, however, it is sufficient if the amplitude is below the predetermined value). Otherwise, even a temporal averaging over several points in time would lead to a distorted result due to the oscillations in the filling level.

The methods described herein can furthermore comprise:
estimating a pressure expected due to the different filling levels in the two reservoirs; applying a gas pressure to the reservoir; and
opening the further reservoir to surroundings so that a gas pressure there corresponds to the atmospheric pressure,
where the gas pressure applied to the reservoir corresponds to the pressure estimated due to the different filling levels.

The measures can reduce the waiting period required until a new equilibrium state has been reached after the change in the filling level. The reason for this is that the oscillations described above are suppressed by applying an external pressure that corresponds as closely as possible to that caused by the difference in the filling level in the two reservoirs. The entire calibration process can therefore be accelerated.

The liquid system described herein can also be configured such that it comprises a light barrier arranged at the reservoir which is arranged at a first known height, where the light barrier comprises a light source and a light sensor. In this case, the method can provide that step A) comprises setting the filling level in the reservoir to a known height, and that step C) comprises changing the filling level of the liquid in the reservoir such that the filling level in the reservoir corresponds to the first known height of the light barrier.

The first known height refers to the height at which the light barrier is arranged. This height or its value, respectively, is known. The known height that is set in step A) is known to a user (or a corresponding computer system) through a preceding determination. For example, this is reference point h₀ previously mentioned. Another possibility is a filling instruction for a user in which a certain amount of liquid is added to the reservoir, which corresponds to a certain filling level. The filling level can also be measured manually. In particular, the first known height of the light barrier is not reference point h₀.

The light source and the light sensor can form a horizontal plane that is parallel to a surface of the liquid in the reservoir.

The light barrier can be configured such that it detects when the filling level of the liquid in the reservoir reaches the height, or in other words the horizontal plane, of the light barrier. An exemplary arrangement is such that the light source is arranged on one side of the reservoir and the light sensor is disposed on the opposite side of the reservoir, where the light from the light source impinges on the light sensor. A laser diode is particularly suitable for this, as it can provide a bundled light beam with sufficiently high output. If there is no liquid at the height of the light barrier in the reservoir, a certain light output is measured by the light sensor. If, however, there is liquid at the height of the light barrier (or the filling level is higher than the height of the light barrier), then the output detected by the light sensor is reduced by absorption and/or scattering.

Alternatively, the light barrier can be configured such that the light source and the light sensor are arranged adjacent to each other on the same side of the reservoir. The light is sent through the reservoir and reflected on the opposite side by a reflector, for example, a mirror, back through the reservoir and onto the light sensor. The function of the light barrier is the same as in the example given above, but the light barrier can be cheaper and a holder for the reservoir can be configured in a simpler manner. Such an arrangement of the light source and the light sensor can be arranged/provided, for example, on a PCB board.

In addition to the method described using pressure difference, the use of a light barrier is an alternative way of determining the (absolute) filling level in the reservoir. One advantage is that no closed off liquid system is required for determining the filling level, but the reservoir can also be open to its surroundings. In addition, the calibration can also be carried out for just a single reservoir. To do this, a state in which filling level h in the reservoir is known is used as a starting point and the associated capacitance is measured. The filling level is now adjusted such that it lies in the plane of the light barrier and the capacitance is measured again. This results in two pairs of values for the filling level in the reservoir and the capacitance, and the desired relationship can be determined therefrom.

The light barrier can also be configured such that it comprises a further light sensor, where the further light sensor is arranged at the same height as the light source and the light sensor such that light from the light source impinges on the light sensor when there is no liquid in the first reservoir in the plane, and that light from the light source impinges on the further light sensor when there is liquid in the first reservoir in the plane.

This configuration of the light barrier creates an even clearer signal when the liquid passes the known height of the light barrier. As a result of the refraction of the light through the liquid, light impinges on the second light sensor and the light output measured by the first light sensor decreases accordingly. The proportion of refracted light is typically higher than the scattering and/or absorption in the liquid so that the difference in the light output on the first sensor increases. In addition, a measurement signal that can serve as a verification of the liquid that is present is given at the second sensor.

The liquid system in the configuration with a light barrier at the reservoir can also comprise a further reservoir and a channel. The reservoir and the further reservoir can be connected in a liquid-tight manner via the channel so that the reservoir and the further reservoir are reservoirs that communicated with regard to the liquid so that in particular the liquid can flow through the channel between the reservoir and the further reservoir. Here as well, the reservoir and the further reservoir can be referred to as the first and the second reservoir.

In this case, the starting point is the state in which filling level h is the same in both reservoirs. This filling level is set as the reference or zero point, for example h=0 or referred to as h₀, and the associated capacitance is measured. The filling level is now adjusted analogously such that it lies in the plane of the light barrier and the capacitance is measured again.

If the two communicating reservoirs have the same geometry, the difference in the filling level between the initial state and the state in the first reservoir corresponds to that difference in the second reservoir (with the opposite sign). Consequently, the filling level in the second reservoir is also known.

A further or second light barrier, respectively, can be arranged at a second known height at the first reservoir, where the light barrier and the second light barrier otherwise have the same properties. The method can therefore be extended in that a further filling level in the reservoir is set that corresponds to the second known height and the associated capacitance is measured. This results in more pairs of values for the filling level and the capacitance, which enables more precise calibration.

The analogous advantage can be achieved if the further or second light barrier is arranged at a second known height at the second reservoir. Since the change in the filling level in the reservoirs around the zero point is of the same magnitude, the capacitance can also be measured and a pair of values can be determined for the second known height. For each additional light barrier at the liquid system, a further pair of values can be determined and the calibration can be refined therewith.

It is also conceivable to arrange further light barriers in addition to the first and the second light barrier at the first or the second reservoir. These further light barriers are arranged at further known heights and, as previously described, enable the determination of a pair of values from the capacitance and the filling level if the filling level corresponds to the known value of the height of the associated light barrier.

The light barrier can be arranged below the starting point and be used in particular to determine whether the reservoir is running dry. If it is registered that the filling level has dropped to the height of the light barrier, it can be set accordingly such that no further liquid be taken from the reservoir. One disadvantage of a reservoir that has run dry is, for example, that the liquid can no longer be pumped towards the second reservoir when the first reservoir is empty. In this case, no nutrient solution is available for cell cultivation or it has to be pumped in the opposite direction, which can change or negatively influence the cultivation conditions.

The liquid system described at the outset can also have a capacitance barrier arranged at the reservoir which is arranged at a first known height. In this case, the method can provide that step A) comprises setting the filling level in the reservoir to a known height, and that step C) comprises changing the filling level of the liquid in the reservoir such that the filling level in the reservoir corresponds to the first known height of the capacitance barrier.

With regard to the known height and the first known height of the capacitance barrier, the analogous considerations apply like in the context of the light barrier.

A capacitance barrier is understood to be a device with which a change in the filling level can be detected by a strong change in the capacitance. The advantage of a capacitance barrier, for example, compared to a light barrier, is that it is simple and inexpensive to manufacture and is less susceptible to misalignment and contamination.

In addition, the properties described of the liquid system with one or more light barriers can be transferred analogously to a liquid system with one or more capacitance barriers. The advantages described arise in the same way.

The calibration method can serve as a basis for determining a flow from the reservoir, or between the reservoir and the further reservoir, respectively, in a dynamic liquid system in which the filling level of the liquid in the two reservoirs changes over time. This determination is based on the previously determined relationship between the filling levels in the reservoir and the electrical capacitances measured, as well as a temporal progression of the electrical capacitance measured by the capacitance sensor. Furthermore, the geometric dimensions of the reservoir must be known, in particular the cross-sectional area A.

First, a functional relationship between the determined filling level and the capacitance measured can be determined by interpolation (linear interpolation, spline interpolation, etc.) and/or extrapolation. If there are two pairs of values for the filling level and the capacitance, linear interpolation is advisable; if there are more pairs of values, other interpolation and/or extrapolation methods can also be used. In this way, capacitance C is obtained as a function of filling level h (written as C(h)). In a dynamic liquid system, filling height h(t) is a function of time t and, accordingly, the capacitance is also a function of time: C(t).

Flow Φ denotes a change in volume per unit of time, in the present case therefore the amount of liquid that flows out of or into the reservoir in a certain time. Since the volume is the product of the height difference between two points in time and the cross-sectional area A, it arises that Φ=A·d/dt h(t).

Finally, when taking into account the relationship determined between the filling heights and the associated values for the capacitance, the flow is obtained from the equation Φ(t)=A·B·d/dt C(t), where B is a calibration factor that arises from the relationship determined. The flow is therefore a function of the electrical capacitance and the time.

Embodiments described herein provide a liquid system comprising a first reservoir filled with a liquid, a second reservoir filled with a liquid, and a channel, where the channel connects the first reservoir and the second reservoir in a liquid-tight manner such that the first reservoir and the second reservoir are reservoirs that communicated with regard to the liquid. Furthermore, the liquid system comprises a capacitance sensor configured to measure the electrical capacitance at the first reservoir and/or the second reservoir. The liquid system further comprises one of a differential pressure sensor for measuring a pressure difference between the first reservoir and the second reservoir, a light barrier arranged at a first known height at the first reservoir or the second reservoir and comprising a light source and a light sensor, and a capacitance barrier arranged at a first known height at the first reservoir or the second reservoir. Finally, the liquid system comprises a control unit configured to carry out the previously described method at a liquid system with two reservoirs.

Depending on the type of method described, the liquid system comprises a differential pressure sensor, a light barrier, or a capacitance barrier. However, it is possible to have more than one of these elements provided in a liquid system.

The control unit can be a computer with appropriate programming so that the steps described in the calibration method can be carried out. In addition, the control unit can be connected to devices of the liquid system, for example, to the capacitance sensor, to a differential pressure sensor, to a light barrier and to a capacitance barrier, for being able to carry out the steps of the method described.

The control unit can comprise a memory in which calibration parameters and/or other parameters and values can be stored.

The liquid system with the control unit is therefore able to carry out the calibration in an automated manner in that the steps are implemented in a computer. Manual steps that have to be carried out by a user are then not necessary.

The liquid system can furthermore comprise a pump that is configured to transport the liquid between the first reservoir and the second reservoir. The pump is configured in particular such that it can transport the liquid in both directions, i.e. from the first reservoir to the second reservoir and from the second reservoir to the first reservoir. In addition, the liquid system can have a microfluidic chip through which the liquid flows.

The pump can comprise a first pressure device, in particular an air pressure pump, a piston pump, a diaphragm pump, a peristaltic pump, a syringe or a syringe pump, for pressurizing the first reservoir. The pressure device can be suitably selected depending on the type of application and surroundings conditions. For example, a syringe pump can be selected if the valve devices comprise self-controlled check valves. The pump can comprise a second pressure device, in particular a pressure pump, a piston pump, a diaphragm pump, a peristaltic pump, a syringe or a syringe pump, for pressurizing the second reservoir.

Pressure is to mean both positive pressure as well as negative pressure. In the case of negative pressure, the fluid would therefore be sucked in.

In particular, one or both of the pressure devices described above can be connected to a respective reservoir via a fluid channel filled at least in part with gas, for example, a hose, in such a way that the respective reservoir can be pressurized.

In particular, the pump can be configured such that the second reservoir can be subjected to a negative pressure, while the first pressure device applies a positive pressure to the first reservoir.

A microfluidic chip can comprise a channel or a channel system through which the liquid flows. The microfluidic chip contains, for example, cell cultures or tissue samples, the behavior of which is to be studied under a certain flow. For example, this can be a cell culture carrier with at least one reservoir and at least one channel.

The liquid system therefore provides the possibility of carrying out biological simulations under precisely controllable conditions.

In addition, the control unit can be configured to regulate the flow through the microfluidic chip using a control loop. By implementing a control loop between the capacitance sensor, the control unit, and the pump, the flow can be actively regulated.

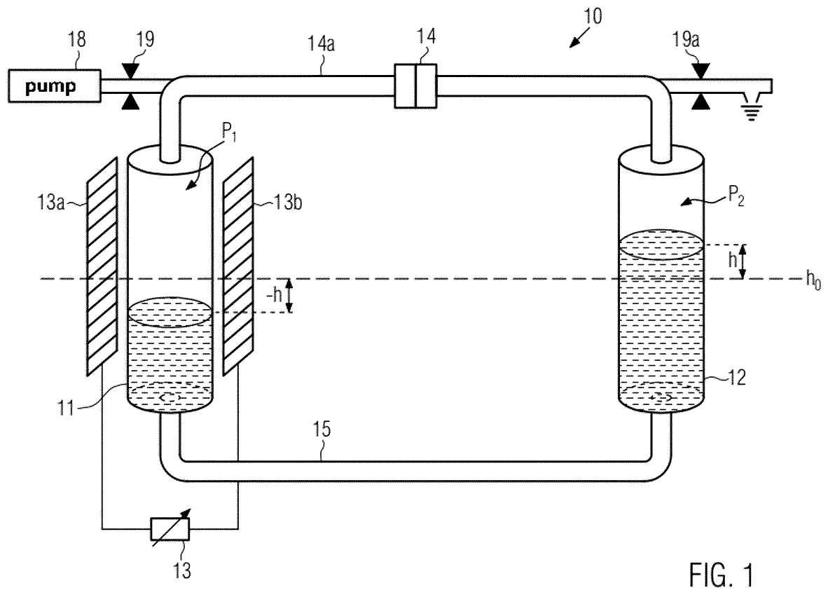

FIG. 1 shows a liquid system 10 according to a first example at which the calibration method described above can be carried out. Liquid system 10 comprises a reservoir 11 and a further reservoir 12. Hereinafter, the reservoirs are referred to as first reservoir 11 and second reservoir 12. Both reservoirs are filled with liquid. There is a gas, for example, air above the liquid level in the two reservoirs.

First reservoir 11 has the shape of a cylinder. In particular, first reservoir 11 and second reservoir 12 have the same dimensions, i.e. are identical in structure. In addition, the two reservoirs are disposed at the same height with respect to a reference plane. Preferably, the two reservoirs are transparent and/or electrically insulating. A transparent reservoir has the advantage that a user of liquid system 10 has a better overview of the liquid levels and can carry out manual measurements. An electrically insulating reservoir is advantageous for the capacitance measurement illustrated hereafter, but is not absolutely necessary.

The two reservoirs are connected to one another in a liquid-tight manner by a channel 15 so that first reservoir 11 and second reservoir 12 are communicating reservoirs with regard to the liquid. In other words, the liquid can flow between the two reservoirs and in both directions, and not via any other path. The entrance to channel 15 is there located in the base surface of the respective reservoir.

A capacitance sensor 13 is arranged at first reservoir 11 and is configured to measure an electrical capacitance on first reservoir 11. In the example shown, capacitance sensor 13 comprises two circuit boards 13a and 13b which are arranged parallel to one another so that first reservoir 11 is arranged between two circuit boards 13a, 13b. The two circuit boards therefore form a plate capacitor with first reservoir 11 arranged therein. Two circuit boards 13a, 13b can be shaped such that they surround first reservoir 11 along its entire height. However, like in the example shown, it can be that circuit boards 13a, 13b surround only a section of the entire height of first reservoir 11. It should only be observed that it can be advantageous to have the circuit boards surround that height region of the first reservoir in which the liquid is typically disposed during operation. Two circuit boards 13a, 13b are connected to a measuring unit that determines the electrical capacitance of the plate capacitor.

Capacitance sensor 13 can also be configured differently. Suitable capacitance sensors are, for example, “FDC1004 4-channel Capacitance-to-Digital Converter for Capacitive Sensing Solutions” from Texas Instruments and “AD7745/AD7746 24-Bit Capacitance-to-Digital Converter” from Analog Devices. Typical measurement signals are in the range between 0.01 and 10 pF (picofarad).

Since the liquid has a higher electrical permittivity than the gas, the capacitance of the plate capacitor changes with a change in the filling level of the liquid. The capacitance there is approximately proportional to the filling level. Nevertheless, the exact value of the capacitance depends on the properties of the liquid, such as temperature, salt concentration or oxygen content. Therefore, to improve accuracy, calibration of the capacitance is performed as a function of the filling level. This can be accomplished efficiently using the method described.

Liquid system 10 furthermore comprises a differential pressure sensor 14. Each of the two reservoirs in its cover surface comprises an inlet into a gas channel 14a which is respectively connected to differential pressure sensor 14. In this way, differential pressure sensor 14 is able to measure a pressure difference of the gas in first reservoir 11 and second reservoir 12. The gas phase of the two reservoirs is not connected via gas channel 14a, but is separated by differential pressure sensor 14. Accordingly, no gas exchange takes place between the two reservoirs. Liquid system 10 shown is therefore closed off from its surroundings.

Instead of a differential pressure sensor 14, the pressure can also be measured separately in both reservoirs by having first reservoir 11 and second reservoir 12 each have a pressure sensor to measure the gas pressure. The differential pressure then arises from the difference in the pressures measured.

A height h₀ is drawn in in the figure. This height indicates the filling level of the liquid in an equilibrium state when gas pressures P₁ (in first reservoir 11) and P₂ (in second reservoir 12) are identical, for example, when the reservoirs are open to the surroundings so that atmospheric pressure prevails. This height can be regarded as a reference or zero point. If a pressure is now applied to one of the reservoirs so that P₁≠P₂, the situation shown in the figure (P₁>P₂) arises, that the filling levels are no longer the same, but differ from the average height h₀ by a height h with the opposite sign. As previously explained, this height is calculated according to hydrostatics as

$$h = \frac{\vert {P}_{1} - {P}_{2} \vert}{2 ρ g}$$

with density ρ of the liquid and the acceleration due to gravity (location factor) g=9.81 m/s². In other words, the pressure difference measured |P₁−P₂| (or its value) between the two reservoirs gives rise to filling height h through the relationship mentioned, in particular as a deviation from the initial value h₀. The filling height can therefore be determined efficiently and precisely by direct measurement.

If the electrical capacitance is now measured for the two filling levels h₀ and h₀±h, a relationship between the filling level and the capacitance can be determined from these two pairs of values. This allows for efficient calibration of the liquid system.

A pump 18 can be used to apply pressure to one of the reservoirs. In the example shown, pump 18 is fluidically connected to first reservoir 11 and generates pressure P₁ in first reservoir 11. Pump 18 can be connected to or disconnected from first reservoir 11 by way of a shut-off valve 19a. Second reservoir 12 can have a fluidic connection via an outlet or an opening to the surroundings, in particular to atmospheric pressure. In this case, pressure P₂ corresponds to atmospheric pressure (since P₁≠P₂, P₁ does not correspond to atmospheric pressure). This connection likewise comprises a shut-off valve 19b with which second reservoir 12 can accordingly be opened to or closed off from the surroundings.

It is to be noted that when pressure P₁ is applied, an oscillation in the filling level of both reservoirs can occur, in particular if the pressure change is performed quickly compared to characteristic time scales of liquid system 10. The frequency, amplitude, and type of oscillation (overdamped or underdamped) are determined by system properties such as the diameter of the reservoirs or the length and/or diameter of channel 15. These properties also define the aforementioned characteristic time scale. A measurement of the capacitance should not take place during this oscillation, as this would distort the measurement. The same applies to any averaging over several measured values for the capacitance at different points in time. For this purpose, the measurement can be carried out after a certain waiting period if the filling level is substantially constant over time. The waiting period is typically in the order of seconds to minutes and can depend on the fluidic resistance between the reservoirs. In the case of low fluidic resistance between the reservoirs, for example, the waiting period can be 20 to 120 seconds, 30 to 120 seconds, or 30 to 60 seconds. In the case of high fluidic resistance between the reservoirs, the waiting period can be between 5 minutes and 30 minutes.

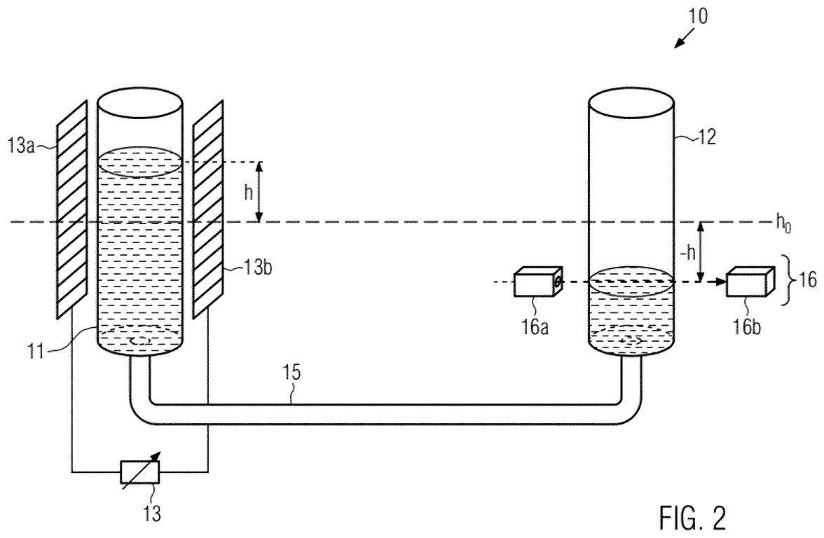

FIG. 2 shows a liquid system 10 according to a second example at which the calibration method previously described can be carried out. Since the liquid systems of both examples are identical in some aspects, only the distinguishing features shall presently be discussed in order to avoid redundancies. The main difference there is the method for determining the filling level of the liquid in first reservoir 11 and/or in second reservoir 12.

Firstly, two reservoirs 11, 12 are not necessarily closed off from their surroundings because the method is not based on a pressure difference of the gas in the two reservoirs. At least one of the reservoirs, in the case shown the second reservoir, instead comprises a light barrier 16. Of course, light barrier 16 can be arranged at first reservoir 11 or light barriers can be arranged at both reservoirs.

Light barrier 16 comprises a light source 16a and a light sensor 16b. These two components are arranged such that the light from light source 16a propagates through second reservoir 11 and then impinges on light sensor 16b. Light source 16a and light sensor 16b are arranged in a horizontal plane and at a known height, which means that light barrier 16 is arranged at a known height. This known height is h₀−h in this case. If there is no liquid at the known height in reservoir 12, a certain light output impinges on light sensor 16b. If, however, there is liquid at the known height in reservoir 12, the light is absorbed and/or scattered in part by the liquid so that the light output measured by light sensor 16b is lower.

An alternative form of the light barrier comprises a further light sensor which is also disposed in the horizontal plane of light barrier 16. The components of light barrier 16 are arranged such that light from the light source impinges on the light sensor when there is no liquid present in the first reservoir in the plane, and that light from the light source impinges on the further light sensor when there is liquid present in the first reservoir in the plane. Light impinges on the further light sensor through refraction when it propagates through liquid, i.e. when there is liquid present at the height of light barrier 16.

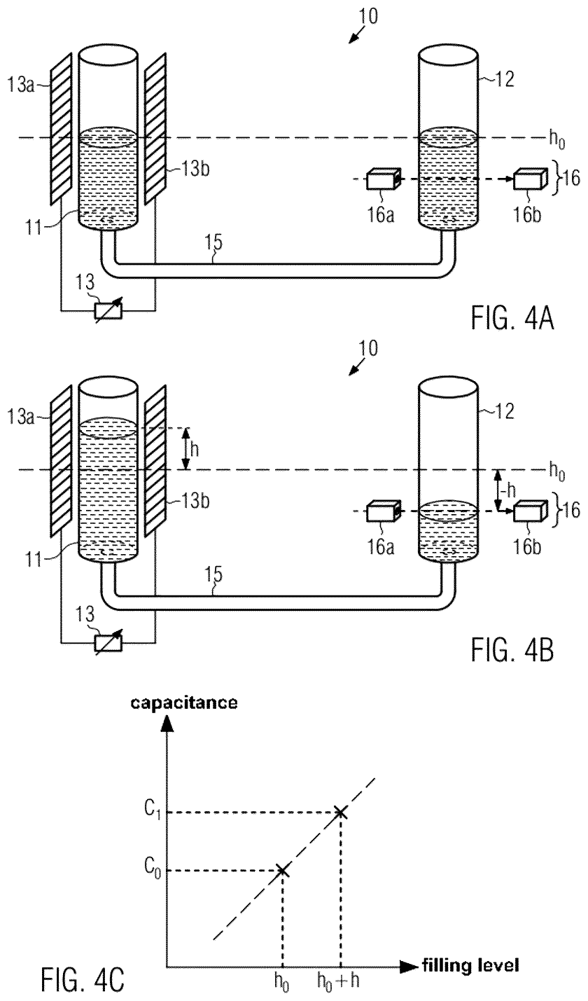

A method for calibration using the liquid system shown shall be explained below with reference to FIGS. 4A-C.

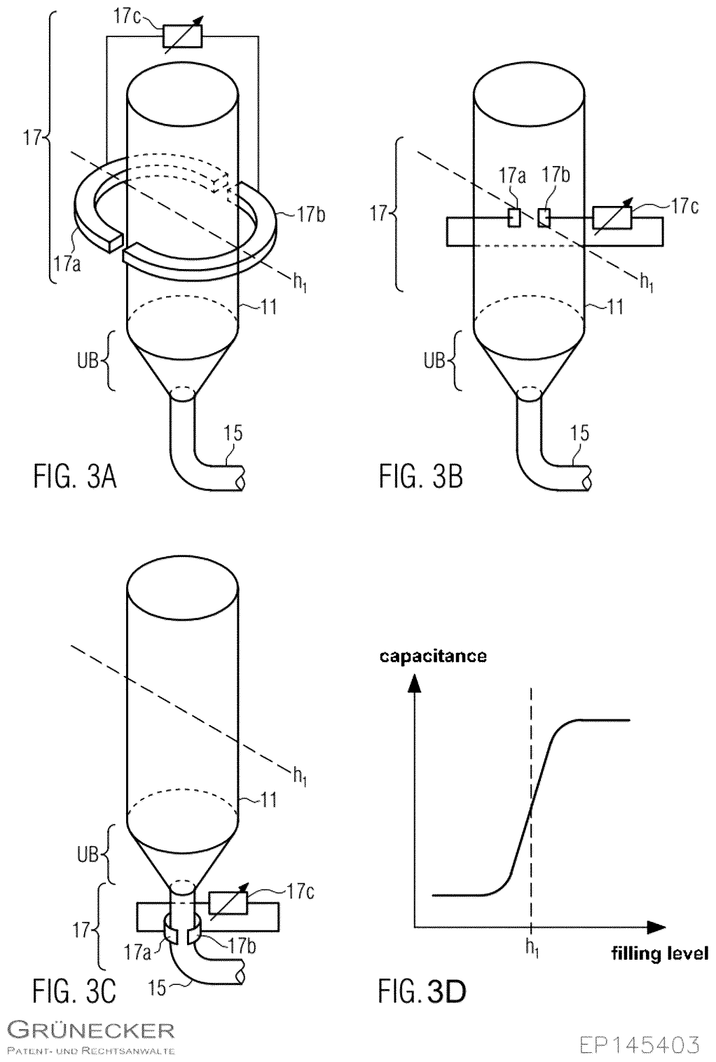

FIGS. 3A to 3C show different variants of a capacitance barrier 17 as it can be arranged at first reservoir 11 and/or second reservoir 12. The capacitance barrier is shown there schematically at first reservoir 11 in a simplified illustration, but capacitance barrier 17 is compatible with the liquid system described and can be used, for example, instead of light barrier 16 in the second example.

The capacitance barrier according to a first variant in FIG. 3A comprises two electrodes 17a, 17b which are arranged at a known height h₁ at reservoir 11. As shown, the electrodes are arc-shaped and surround a large part of the circumference of reservoir 11 at the known height. Two electrodes 17a, 17b form a plate capacitor and are connected to a capacitance sensor 17c, which measures the capacitance of the plate capacitor and therefore of that section of reservoir 11 that is surrounded by capacitance barrier 17. A capacitance barrier provides the advantage over a light barrier that it is largely insensitive to misalignment. In comparison, it must be ensured with a light barrier that the light from the light source impinges on the light sensor or light sensors. Such an adjustment is not necessary for the capacitance barrier.

FIG. 3B shows a capacitance barrier 17 according to a second variant. The electrodes there are small in size relative to the size of the reservoir and are arranged close to each other without touching each other. Compared to the previously mentioned embodiment, this embodiment has the advantage of improved spatial resolution (and thus allows for more precise height determination), but at the same time has a poorer signal-to-noise ratio.

In a third variant according to FIG. 3C, capacitance barrier 17 is attached to channel 15 that connects the first reservoir to the second reservoir (not shown). Capacitance barrier 17 can be configured as a clip into which channel 15 is inserted. The capacitance of the filling of a section of channel 15 is therefore measured, where this section has a length in the range between 1 mm and 1 cm (the clip accordingly covers a length of channel 15 in the range between 1 mm and 1 cm). In order to be able to calculate a change in volume when using this variant of capacitance barrier 17, the geometry in transition region UB between reservoir 11 and channel 15 must be known. This also applies to the transition region between the second reservoir and the channel.

This variant of capacitance barrier 17 allows for precise measurement of the filling level in the second reservoir due to improved spatial resolution and at the same time serves as protection against first reservoir 11 running dry.

The diagram shown in FIG. 3D shows a schematic profile of the capacitance measured as a function of the filling level of reservoir 11. If the filling level of the liquid is below height h₁ of the capacitance barrier, the capacitance measured is low because gas in the reservoir has a low capacitance. If the filling level is above height h₁ of the capacitance barrier, the capacitance measured is high because the liquid in the reservoir has a higher capacitance than the gas (due to the different electrical permeability between the liquid and the gas). If the filling level of the liquid is around height h₁, then the associated change in capacitance is the highest. Directly at height h₁ is an inflection point (zero point of the first derivative) of the capacitance profile as a function of the filling level. This point is easy to determine in an evaluation of the measured values so that a capacitance barrier is a precise method of determining a specific filling level. In this case, it can be determined very precisely when the filling level reaches value h₁.

FIGS. 4A-C outline a calibration method using liquid system 10 according to the second example with a light barrier. The structural features of liquid system 10 already mentioned shall presently not be explained any more.

In a first step, liquid system 10 is prepared in a state in which the filling level of the liquid in first reservoir 11 is known. This can be achieved, for example, by way of a filling instruction for a user or this filling level is measured separately (manually). Since first reservoir 11 and second reservoir 12 are connected via channel 15, the filling level in the two reservoirs is identical and is designated as h₀ (see FIG. 4A). For this filling level h₀, the electrical capacitance of first reservoir 11, or that section of first reservoir 11 that is surrounded by the electrodes (circuit boards 13a, 13b), respectively, is now measured in a second step using capacitance sensor 13. This measured value C₀ for the capacitance and h₀ form a first pair of values.

In a third step, the filling level in first reservoir 11 (and therefore also in second reservoir 12) is changed so that the new filling level in second reservoir 12 corresponds to the known height (h₀−h) of light barrier 16. Since this is a known filling level, it does not have to be determined separately. In a fourth step, capacitance C₁ is now measured again at first reservoir 11. Since the two tubes communicate, the filling level in first reservoir 11 is exactly (h₀+h), see FIG. 4B. C₁ and (h₀+h) form a second pair of values.

The fifth step is now illustrated in FIG. 4C. The two pairs of values determined are there entered as points (marked by x) in a diagram in which capacitance C is plotted against filling level h. An extrapolating straight line can be drawn through the two points so that a (functional) connection can be determined as a relationship between the filling level and the capacitance. In this case, a linear relationship C(h)=a+b·h with parameters a and b therefore applies.

It is to be mentioned that the method described can also be carried out in an analogous manner with a capacitance barrier instead of light barrier 16. The method described can also be carried out in conjunction with a liquid system according to the first example, i.e. with a differential pressure sensor

Starting out from this static calibration, flow @ can now be determined in a dynamic liquid system in which the filling level changes as a function of time t. As previously described, the flow refers to a change in volume per time, which is defined as

$$Φ = A \cdot \frac{d}{d t} h ( t ) ,$$

d/dt refers to the derivative with respect to time t. Based on the relationship determined between the capacitance and the filling level, the flow therefore arises for

$$Φ ( t ) = A \cdot B \cdot \frac{d}{d t} C ( t )$$

with B=1/b a parameter that results from the calibration.

Finally, the flow can be obtained solely from a measurement of the capacitance. Therefore, the flow can be determined in real time and with great precision, which can be advantageous and important in certain cases of application. In addition, it is possible to control the flow on the basis of a single measured value, for example, by way of a feedback loop.

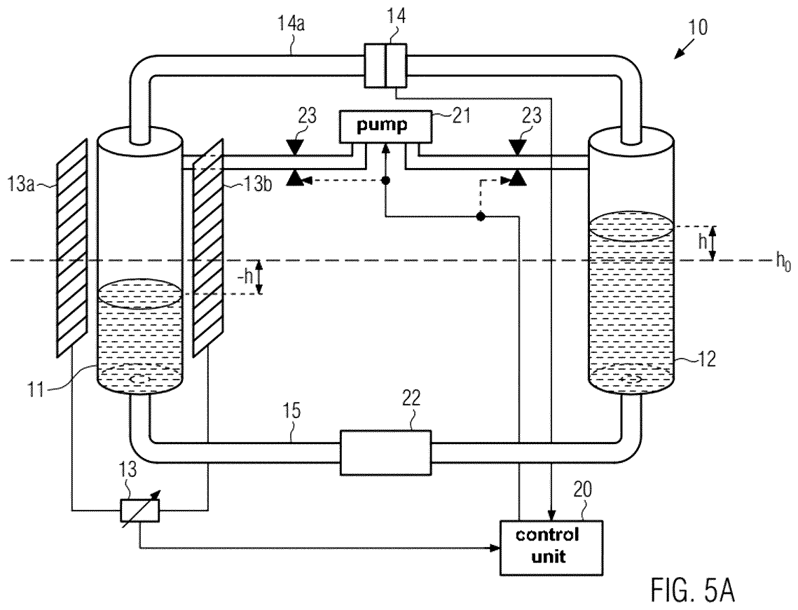

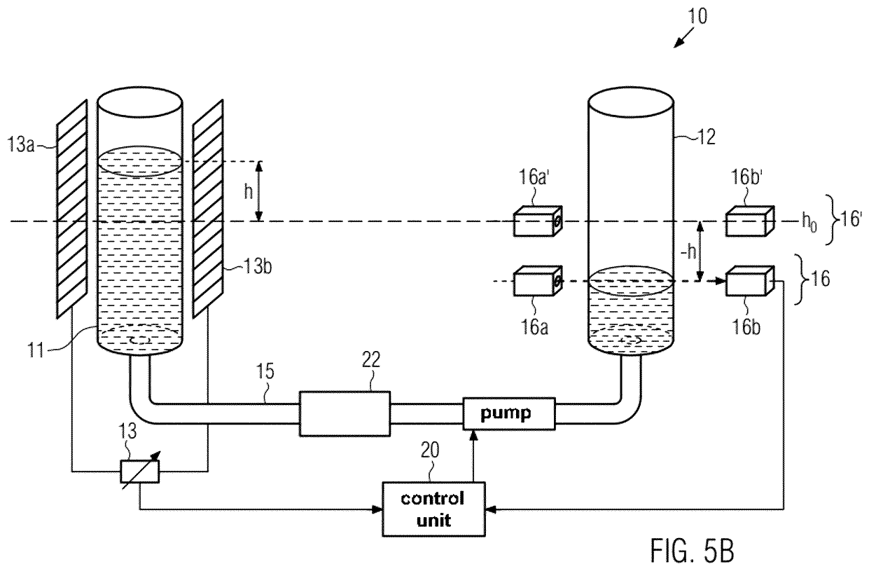

Furthermore, FIG. 5A shows a liquid system 10 according to the invention according to a first embodiment. In addition to the elements already explained, liquid system 10 comprises a control unit 20 which is configured to carry out the calibration method according to the invention described herein by determining a pressure difference between the two reservoirs at liquid system 10.

A pump 21 is connected to the two reservoirs and is configured to control the gas pressure in the two reservoirs. By controlling the gas pressure, pump 21 has direct influence on the filling level in the reservoirs and the amount of liquid transported through the channel. Pump 21 can be configured to apply different pressures in the two reservoirs or to control the pressure in the two reservoirs independently of one another. For example, a certain pressure P₁ can be applied to first reservoir 11, while ambient pressure or atmospheric pressure is applied to second reservoir 12. In particular, P₁ does not correspond to atmospheric pressure. Liquid system 10 additionally comprises a microfluidic chip 22 at channel 15 so that the liquid can flow through microfluidic chip 22. The microfluidic chip contains, for example, cell cultures or tissue samples, the behavior of which is to be studied under a certain flow.

Control unit 20 receives signals and/or data from capacitance sensor 13 and differential pressure sensor 14 and is configured to control pump 21. Liquid system 10 can also comprise valves 23 to close off the reservoirs from the pump. These valves can also be controlled (e.g. opened and closed) by the control unit. In this way, control unit 20 is configured to carry out the calibration method previously described at liquid system 10. For explanation, reference is made to the method steps mentioned above:
Step A): Differential pressure sensor 14 transmits the pressure difference between the two reservoirs, and the control unit uses this to calculate the difference in the filling level between the two reservoirs.
Step B): Capacitance sensor 13 measures the capacitance at first reservoir 11 and transmits the measured value to control unit 20.
Step C): Control unit 20 controls pump 21 to set a new filling level in that pump 21 changes the pressure in first reservoir 11 and/or second reservoir 12.
Step D): Repeating steps A) and B),
Step E): Control unit 20 determines a relationship between the filling levels in reservoir 11 and the electrical capacitances measured.

Control unit 20 can be a computer that has implemented the necessary instructions for carrying out the method.

The calibration method can therefore be carried out in an automated manner and does not require any manual settings by a user. The calibration parameters determined can be saved/stored in a memory (external or within the control device).

In addition, after calibration, the flow in this liquid system 10 can also be determined from the data provided by capacitance sensor 13 and the calibration parameters in that the control unit carries out the previously disclosed steps for calculating the flow. In this context, the flow through the microfluidic chip can be controlled in that the control unit controls pump 21 to achieve a certain flow. By implementing a control loop between capacitance sensor 13, control unit 20, and pump 21, the flow can also be actively regulated.

Finally, FIG. 5B shows a liquid system 10 according to a second embodiment. It differs from the first embodiment in that a light barrier 16 is used at second reservoir 12 at a known height h₀−h for determining the filling level of the liquid. The calibration method described using a light barrier can be carried out at this liquid system 10. Accordingly, no differential pressure sensor and no associated gas channel are provided and the reservoirs do not generally have to be closed off from their surroundings. Furthermore, the pump is arranged at channel 15 and configured to deliver the liquid between first reservoir 11 and second reservoir 12 through channel 15.

Liquid system 10 also comprises a second light barrier 16′ arranged at second reservoir 12 with a light source 16a′ and a light sensor 16b′ at the also known height h₀. This arrangement enables the capacitance to be calibrated at two filling levels of second reservoir 12. As already explained, it is possible to determine the calibration from two pairs of values, and from this the flow. Liquid system 10 shown therefore represents an option for determining the flow based on a calibration according to the method described.

It is also possible to arrange more than two light barriers at known heights hᵢ at second reservoir 12.

It goes without saying that the one or more light barriers can also be arranged at first reservoir 11. In this example, it is to be noted that the light barrier(s) are not obstructed by capacitance sensor 13.

With regard to the calibration method using a liquid system 10 with a light barrier, reference is made to the above explanations. In addition, some steps can be applied analogously to liquid system 10 of the first embodiment described. Overall, this liquid system 10 of the second embodiment also provides the advantages of automated calibration of the system and the option of implementing a control loop for controlling the flow through microfluidic chip 41.

1. A calibration method for a liquid system, wherein the liquid system comprises:
a first reservoir filled with a liquid; and
a capacitance sensor which is configured to measure electrical capacitance at the first reservoir,
the method comprising:
determining a filling level of the liquid in the first reservoir;
measuring, with the capacitance sensor, a first electrical capacitance at the first reservoir for the filling level of the liquid;
setting a different filling level in the first reservoir;
determining the different filling level of the liquid in the first reservoir;
measuring, with the capacitance sensor, a second electrical capacitance at the first reservoir for the different filling level; and
determining a relationship between filling level and electrical capacitance based on the filling level and the different filling level in the first reservoir and the first electrical capacitance and the second electrical capacitance.

2. The method of claim 1, wherein the liquid system further comprises:
a second reservoir filled with the liquid; and
a channel which connects the first reservoir and the second reservoir in a liquid-tight manner so that the first reservoir and the second reservoir are reservoirs that communicate with regard to the liquid,
wherein each of the first reservoir and the second reservoir are filled with the liquid and a gas,
wherein the first reservoir and the second reservoir are closed off from their surroundings; and
wherein determining the filling level of the liquid in the first reservoir comprises:
determining a pressure difference between the gas in the first reservoir and the gas in the second reservoir; and
determining the filling level in the first reservoir based on the pressure difference.

3. The method of claim 2, wherein determining the pressure difference is carried out after a waiting period.

4. The method of claim 3, wherein the pressure difference is measured at several points in time after the waiting period and measured values of the several points in time are averaged.

5. The method of claim 2, further comprising:
estimating a pressure expected due to different filling levels in the first reservoir and the second reservoir;
applying a gas pressure to the first reservoir; and
opening the second reservoir to surroundings so that a gas pressure in the second reservoir corresponds to atmospheric pressure,
where the gas pressure applied to the first reservoir corresponds to the pressure estimated due to the different filling levels.

6. The method of claim 1, wherein the liquid system further comprises a light barrier arranged at the first reservoir,
wherein the light barrier is arranged at a first known height,
wherein the light barrier comprises:
a light source; and
a first light sensor; and
wherein determining the filling level of the liquid in the first reservoir comprises setting the filling level in the first reservoir to the known height, and
wherein setting the different filling level in the first reservoir comprises changing the filling level of the liquid in the first reservoir so that the filling level in the first reservoir corresponds to the first known height of the light barrier.

7. The method of claim 6, wherein the light barrier comprises a second light sensor, and
wherein the light source, the first light sensor and the second light sensor are arranged in a horizontal plane such that light from the light source impinges on the first light sensor when there is no liquid present in the first reservoir in the horizontal plane, and that light from the light source impinges on the second light sensor when there is liquid present in the first reservoir in the horizontal plane.

8. The method of claim 6, wherein the liquid system comprises a second reservoir and a channel which connects the first reservoir and the second reservoir in a gas-tight manner and a liquid-tight manner so that the first reservoir and the second reservoir are communicating reservoirs.

9. The method of claim 6, wherein the first known height of the light barrier is lower than the filling level in the first reservoir, and
wherein the light barrier is used to determine whether the first reservoir is running dry.

10. The method of claim 6, wherein a second light barrier is arranged at a further known height at the first reservoir, and
wherein the liquid system is configured such that the filling level in the first reservoir corresponds to the further known height.

11. The method of claim 1, wherein the liquid system further comprises a capacitance barrier arranged at the first reservoir,
wherein the capacitance barrier is arranged at a first known height,
wherein determining the filling level of the liquid in the first reservoir comprises setting the filling level in the first reservoir to a first known height, and
wherein setting the different filling level in the first reservoir comprises changing the filling level of the liquid in the first reservoir so that the filling level in the first reservoir corresponds to the first known height of the capacitance barrier.

12. The method of claim 11, wherein the liquid system comprises a second reservoir and a channel which connects the first reservoir and the second reservoir in a gas-tight manner and a liquid-tight manner so that the first reservoir and the second reservoir are communicating reservoirs.

13. The method of claim 1, further comprising determining a flow, wherein determining the flow comprises:
dynamic development of the liquid system in which the filling level in the first reservoir changes over time; and
determining the flow from the relationship determined between the filling levels in the first reservoir and the first electrical capacitance and the second electrical capacitance, a temporal progression of electrical capacitance measured by the capacitance sensor, and known geometric dimensions of the first reservoir.

14. A liquid system, comprising:
a first reservoir filled with a liquid;
a second reservoir filled with the liquid;
a channel which connects the first reservoir and the second reservoir in a liquid-tight manner so that the first reservoir and the second reservoir are reservoirs that communicate with regard to the liquid;
a capacitance sensor which is configured to measure electrical capacitance at one or more of the first reservoir or the second reservoir;
at least one of:
a differential pressure sensor for measuring a pressure difference between the first reservoir and the second reservoir;
a light barrier which is arranged at a first known height at said first reservoir or said second reservoir and comprises a light source and a light sensor, or
a capacitance barrier which is arranged at a first known height at said first reservoir or said second reservoir; and
a control unit which is configured to;
determine a filling level of the liquid in the first reservoir;
measure, with the capacitance sensor, a first electrical capacitance at the first reservoir for the filling level of the liquid;
set a different filling level in the first reservoir;
determine the different filling level in the first reservoir;
measure, with the capacitance sensor, a second electrical capacitance at the first reservoir for the different filling level; and
determine a relationship between filling level and electrical capacitance based on the filling level and the different filling level in the first reservoir and the first electrical capacitance and the second electrical capacitance.

15. The liquid system of claim 14, further comprising:
a pump which is configured to transport the liquid between the first reservoir and the second reservoir.

16. The liquid system of claim 14, further comprising:
the light barrier which is arranged at a known height at the first reservoir or at the second reservoir and that comprises the light source and the light sensor,
wherein to determine the filling level of the liquid in the first reservoir, the control unit is configured to set the filling level in the first reservoir to the known height,
and wherein to set the different filling level in the first reservoir, the control unit is configured to change the filling level of the liquid in the first reservoir so that the filling level in the first reservoir corresponds to the known height of the light barrier.

17. The liquid system of claim 16, wherein the light source comprises a laser diode.

18. The liquid system of claim 14, further comprising:
the capacitance barrier which is arranged at the first known height at the first reservoir or at the second reservoir,
wherein to determine the filling level of the liquid in the first reservoir, the control unit is configured to set the filling level in the first reservoir to a second height,
and wherein to set the different filling level in the first reservoir, the control unit is configured to change the filling level of the liquid in the first reservoir so that the filling level in the first reservoir corresponds to the first known height of the capacitance barrier.

19. The liquid system of claim 14, further comprising:
a microfluidic chip through which the liquid flows.

20. The method of claim 3, wherein the waiting period corresponds to when the liquid system has reached an equilibrium state in which the pressure difference is substantially constant over time.
